(19) United States
(12) Patent Application Publication
(10) Pub. No.: US 2015/0364064 A1
(43) Pub. Date: Dec. 17, 2015

(54) Compact Sign

(71) Applicants: Russell Richard Smith, Bolivar, MO (US); Kenneth Dale Coleman, Branson, MO (US)

(72) Inventors: Russell Richard Smith, Bolivar, MO (US); Kenneth Dale Coleman, Branson, MO (US)

(21) Appl. No.: 14/737,486

(22) Filed: Jun. 12, 2015

Related U.S. Application Data
(60) Provisional application No. 62/105,299, filed on Jan. 20, 2015.
(60) Provisional application No. 62/011,594, filed on Jun. 13, 2014.

(51) Int. Cl. G09F 7/20

(52) U.S. Cl. CPC G09F 7/20; G09F 2007/1843

(57) ABSTRACT

The present invention pertains to a collapsible style sign. More specifically, the invention pertains to a Compact Sign with an erect frame that has a span that is substantially larger than that of the closed frame, thus allowing the erect frame to hold a large face while the closed frame is compact and easy to store. Compact Signs are great for residential and commercial real estate use, but they are not limited to outdoor applications.

### CROSS-REFERENCES TO RELATED APPLICATIONS

This application claims the benefit of U.S. provisional patent No. 62/011,594 that was filed on Jun. 13, 2014, and provisional patent application No. 62/105,299 that was filed on Jan. 20, 2015. These references will be discussed below.

### FIELD OF THE INVENTION

The disclosed invention generally pertains to a collapsible style sign. More specifically, the invention pertains to a Compact Sign with an erect frame that has an arm span that is substantially larger than that of the closed frame, thus allowing the erect frame to hold a large face while the closed frame is compact and easy to store. The face of the sign is designed to be collapsible thus further reducing the overall size of the store sign. The Compact Sign is great for residential and commercial real estate use all though it is not limited to outdoor applications.

### BACKGROUND OF THE INVENTION

In many instances companies or individuals like to take advantage of ground space to advertise various campaigns, sales, or business related events to the public. Often time this is done via transportable yard signs that display a sign face containing the desire public message. Yard signs come in all shapes, and designs, but what is important for most signs is the aesthetics, and the elevation height of the face. Signs that are too low can become hidden by grass, or small bushes that render the sign less useful, while a lack of aesthetics often time indicates a lack of professionalism of the company of individual that it is advertising.

It is quite common for business personnel, such as real estates agents, to have to set up multiple yard signs on a daily basis. To do so, the signs must first be transported to the selected site, which typically requires that the agent try and fit several large signs in their car without causing scratches or dents to the vehicle. Simply placing multiple signs in a car can allow for the signs to rattle against each other making it very difficult to communicate with clients that are in the vehicle with you, and causing damage to the signs.

Once at the desire location for the sign, the sign must either be set on the ground and left, which means that the sign must be heavy enough to now blow away, or it must have stake(s) that go into the ground. The heavier sign obviously makes it harder to carry, while putting the stakes in the ground can be rough on the sign frame, since often times the stakes are part of the sign frame itself with no direct hitting point except for the top of the sign frame. Thus putting the stakes in hard ground can requires that you hammer on the frame, which causes unwanted damage. Not to mention that many signs required additional tools such as screw drivers and wrenches that take up additional space in the vehicle.

Many yard signs are large and bulky which can required the user to maintain a storage shed. Often times, in the real estate industry, yard signs are simply left outdoors leaning against the company building simply because the signs are not compact enough to store inside without a shed.

It is desirable to provide a lightweight, durable, and easy to use sign that can be more conveniently stored, in the form of a Compact Sign. Although Compact Signs come in multiple sizes, the most commonly used size (real estate) can allow for the user to transport over 20 signs in the average size trunk. They are that compact! A hammer is the only required tool making the assembly for the Compact Sign extremely simple and efficient Compact Signs can be aesthetically pleasing, and well elevated. They are properly designed to be hammered into hard ground without causing substantial damage to the frame. The design allows the user to hit directly on the top(s) of the stake(s) which can reduce destruction of the frame. Although, the Compact Sign is great for outdoor use, it is not limited to outdoor applications. Other desirable aspects of the Compact Sign will become apparent from the remaining portion of this application.

### BRIEF SUMMARY OF THE INVENTION

The disclosed invention pertains to a transportable sign that is compact for storage, and easy to use. There are many variations of the design and this brief summary of the invention is not intended to limit the scope of the invention in any way, as it is merely exemplary.

A Compact Sign comprising a rigid spanning member that establishes the proper spacing and position of two independently movable arms of a frame. The spanning member positions and holds the arms within a small variation of a common plane such that the two arms of an erect frame extended in a common vertical direction. The sign face can be suspended by the arms, and lie within the space that is immediately around and between the two arms.

Each end of the spanning member could be pivotally connected near an end of each arm such that the arms can be rotated to lie parallel and adjacent to each other in the closed position. The arms can then be rotated to the desired angle, relative to the spanning member, and held in position for supporting the sign face. For additional height or compactness, the arms of the sign can be made to extend or telescope.

For stabilizing the frame in an outdoor application, at least one ground stake can be used to hold the frame vertical. This ground stake can be a separate component or it can be attached to the spanning member.

One such design to the Compact Sign could be comprised of:

A spanning member with two elongated side plates that are connected at the top by a bridge in an adjacent but spaced relationship. The two side plates and bridge form a channel shaped structure that holds any components, such as arms and stakes, of the sign together. Each en of the spanning member is connected to an end of one arm by a pivot thus allowing the arms to rotate in an out of the inside of the spanning member. The arms telescope so that additional height is met while still being able to fold the arms so that they lie entirely inside the spanning member. The arms can rotate out of the spanning member more than 180° so that their non-jointed ends lie above the height of the bridge. A stopping mechanism limits the motion of the arms such that in order to be able to bring the arms closed together requires that you bend them thus producing a springing motion that can hold the face taut.

The stakes would lie inside the spanning member between the bridge and the arms in the closed position. After pulling the arms out of the spanning member, the stakes can be rotated out. While one end of a stake can rotate so that it can in the ground, the tope of each stake rotates through a hold in the bridge, thus exposing the top of the stake for direct hitting. The pivot of the stake can be loosely fitting in direction of hammering so that the stake, being accelerated into the ground, doesn't put as much stress on the spanning member as it would otherwise do.

The arms of an erect frame are positioned such that they slightly lean away from each other thus requiring a small bending of the arms to get them pointed in the same direction. A sign face comprised of a soft material, in the shape of a loop, with two desired images printed on it can then be slid over the two arms and be held tight by their spring force. A protrusion in at least one arm extends through a hole in the sign face securing it on the frame.

Such a product could be achieved by metal stamping aluminum side plates and riveting the top of two of them together with the proper spacers in between them, thus forming the spanning member. The arms of the sign can be extruded out of aluminum along with the stakes. The arms and stakes can then be drilled in the proper positions and loosely riveted to the spanning member. A push button, commonly used on crutches, can be inserted into the inside telescoping tube of each arm to allow the arms to lock in the extended position. The face would ideally be constructed out of a billboard/vinyl material with two faces printed side by side. The two faces would then be cut out in one long strip and the two short ends of the strip would be jointed together with a heat seam to form a loop.

### BRIEF DESCRIPTION OF THE DRAWINGS

FIG. 1 is an isometric view of a spanning member that is in the form of a rectangular channel.

FIG. 2 shows an isometric view of a Compact Sign (no face) in the closed position.

FIG. 3 shows a front elevated view of that which is depicted in FIG. 2.

FIG. 4 is a front view of the Compact Sign from FIG. 2 but with one side plate removed, which exposes internal components; the arms of the frame and two stakes in the closed position.

FIG. 5 is an isometric view of that which is illustrated in FIG. 4.

FIG. 6 is a front view of that which is illustrated in FIG. 4 but with the arms partially rotated into the erect position.

FIG. 7 is a front view of that which is illustrated in FIG. 6 but with the stakes partially rotated into the erect position.

FIG. 8 is an isometric view of that which is illustrated in FIG. 7 but with the second side plate reattached.

FIG. 9 show a front view of the Compact Sign from FIG. 8 with the arms fully rotated into the erect position.

FIG. 10 shows a front view of that which is illustrated FIG. 9 but with the stakes fully rotated into the erect position.

FIG. 11 shows a front view of that which is depicted in FIG. 10 but with the arms extended into the erect position.

FIG. 12 is a front elevated view that illustrates that which is depicted in FIG. 11, but with the face of the sign being placed over the tops of the two arms of an erect frame.

FIG. 13 is a front elevated view that illustrates that which is depicted in FIG. 12, but with the face of the sign having been slid down over a top portion of each arm.

FIG. 14 shows a front view of a spanning member with two stakes in the erect position. This image directly correlates with FIG. 15 showing the position changes of the stake during hammering.

FIG. 15 shows a front view of a spanning member with two stakes in the erect position. This image directly correlates with FIG. 14 showing the position changes of the stake during hammering.

FIG. 16 shows an isometric view of a looped sign face that slides over a portion of each arm. Two holes in the face accommodate protrusions on the arms for holding the face to the frame.

FIG. 17 shows the position of a partially erect frame with two stakes. The stakes are positioned as they would be in the ground (ground not shown) with the spanning member lying on the ground. A block 15 can be wedged near the pivot of an arm, and a force can be applied on the arm in such a way that the arm is used as a lever for forcing the stakes out of the ground.

### DETAILED DESCRIPTION OF THE INVENTION

The following detailed description of the invention is simply an example and is not intended to limited the scope, application, or use of the invention. Neither the background of the invention, brief description of the drawings, nor the following detailed description of the invention are intended to be binding or limiting in any way as there are many variations of the Compact Sign.

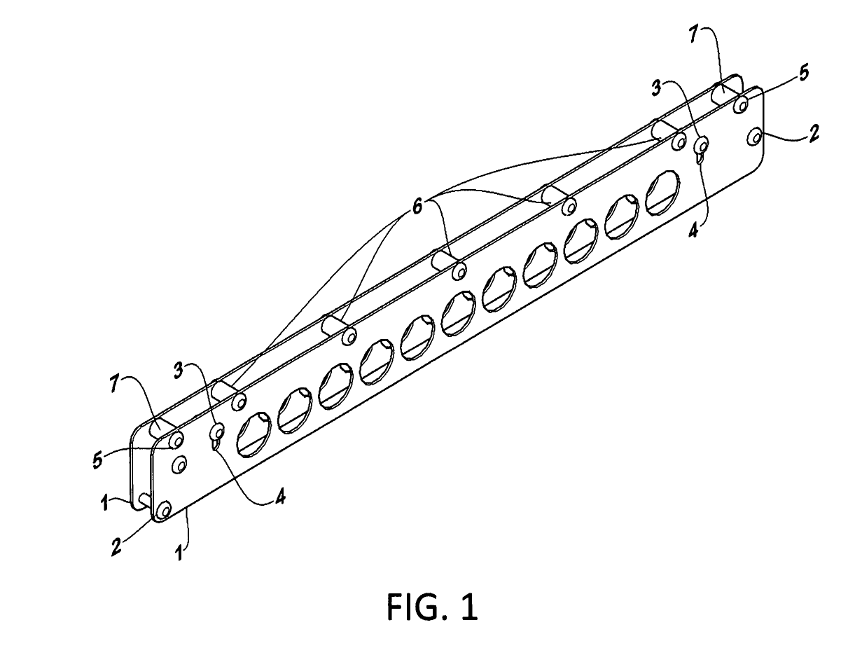

FIG. 1 illustrates a spanning member that has been constructed out of a two elongated side plates, 1. The two side plates are separated by a bridge and pin system 6 that holds the side plates in a spaced relationship forming a channel shaped spanning member. The side plates 1 would ideally be made from aluminum plating and stamped out with a die. The bridge can be constructed by extruding aluminum standoffs, and the pins can consist of solid aluminum rivets.

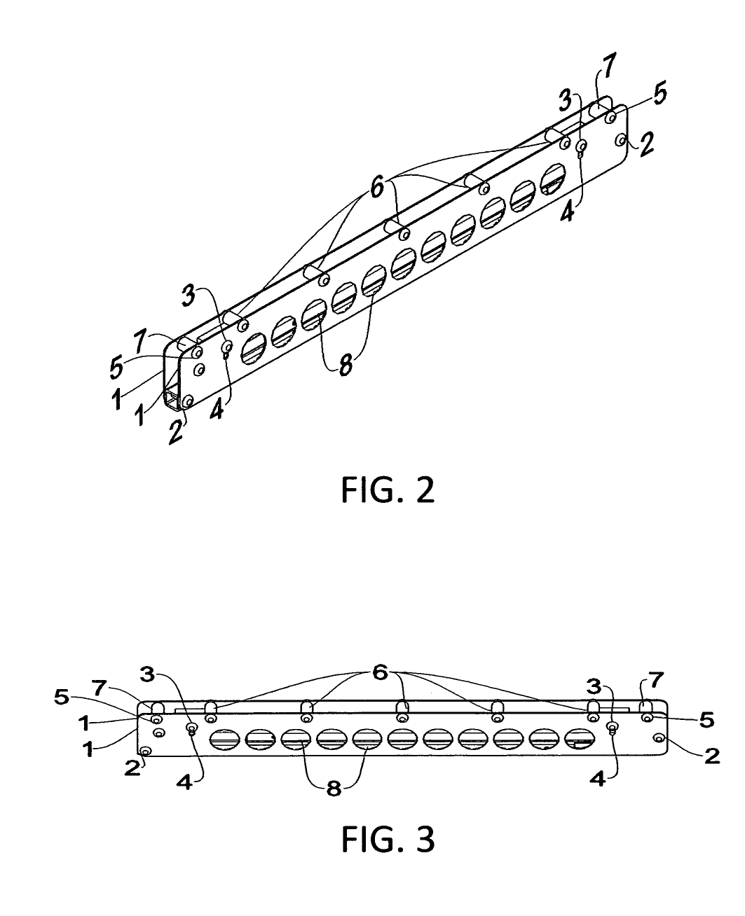

FIGS. 2-3 show the spanning member from FIG. 1 having two arms 8 that pivot about a pin 2 out from inside the spanning member. The pivots 2 can be positioned at different heights on the spanning member so that the arms 8 are positioned, one on top of the other, in the closed position. The arms 8 can be extruded from aluminum, with holes drilled in the proper places, and loosely riveted to the spanning member.

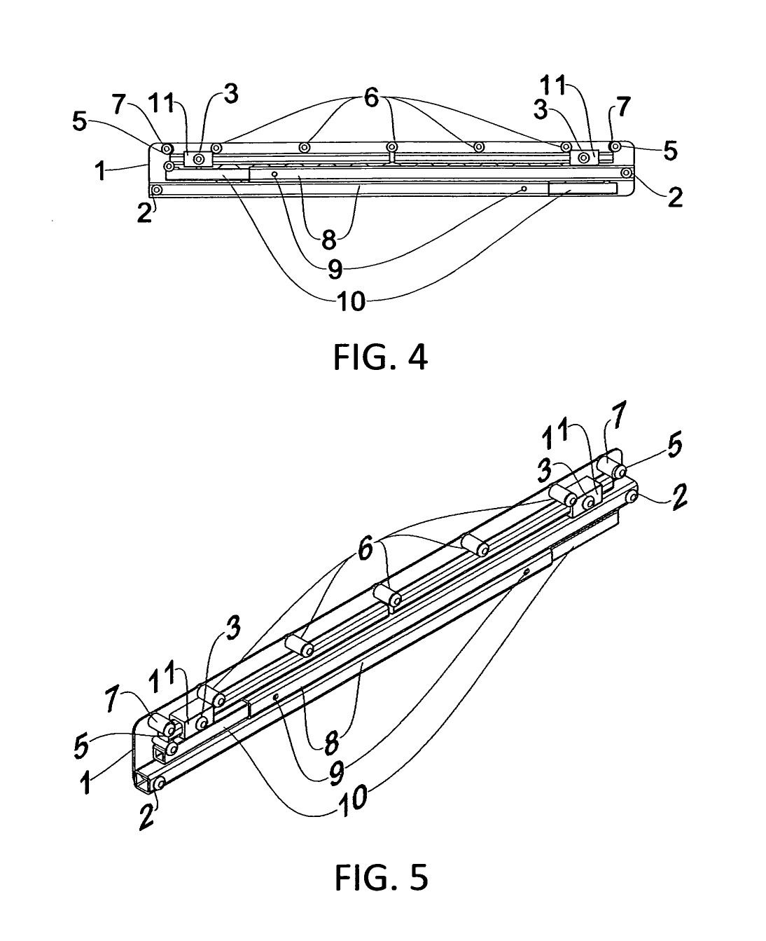

FIGS. 4-5 depict the spanning member of FIG. 1 with one side plate 1 removed and internal components (arms 8 and 10, and stakes 11) attached. Attached to the one side plate 1 are two arms 8 as in FIGS. 2-3, but having an internal component 10 that telescopes out of 8 for additional face height. The stakes 11 are positioned between the arms 8 and 10, and the bridge 6, and laying in line with each other in the closed position. These stakes 11 pivot about pin 3 so that the stakes 11 lie perpendicular to the ground for hammering. The stakes can be constructed of aluminum extruded parts and sharpened on a grinding wheel. A hole can then be drilled in the proper position, and the stake can then be loosely riveted with pin 3 through the holes 4 in the side plates 1. The arms 10 can be extruded from aluminum as well.

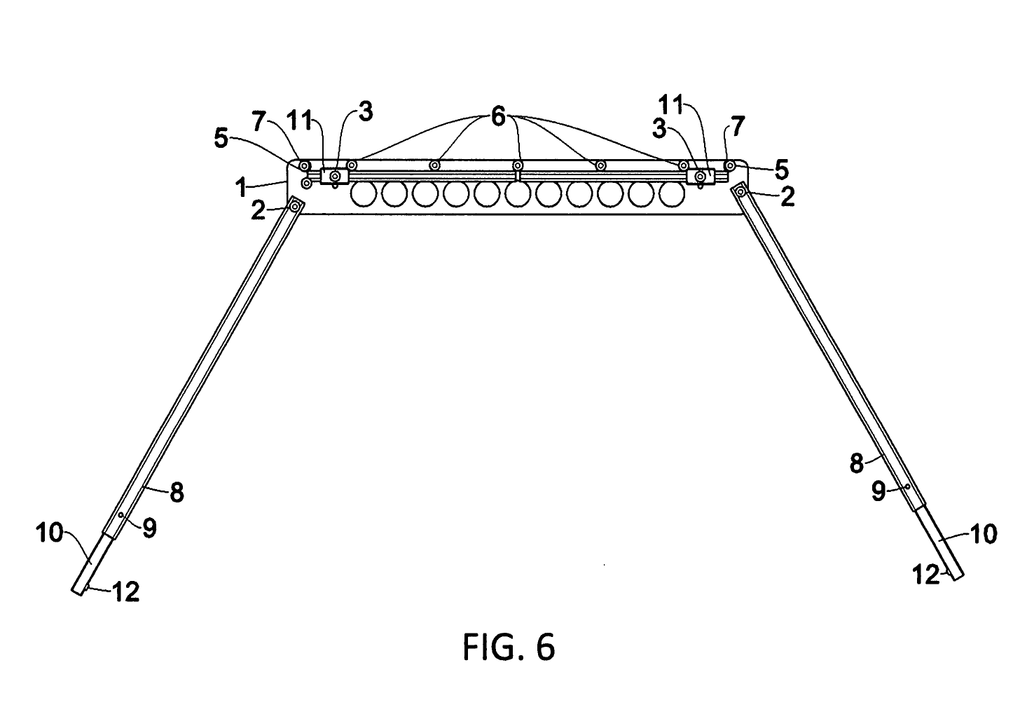

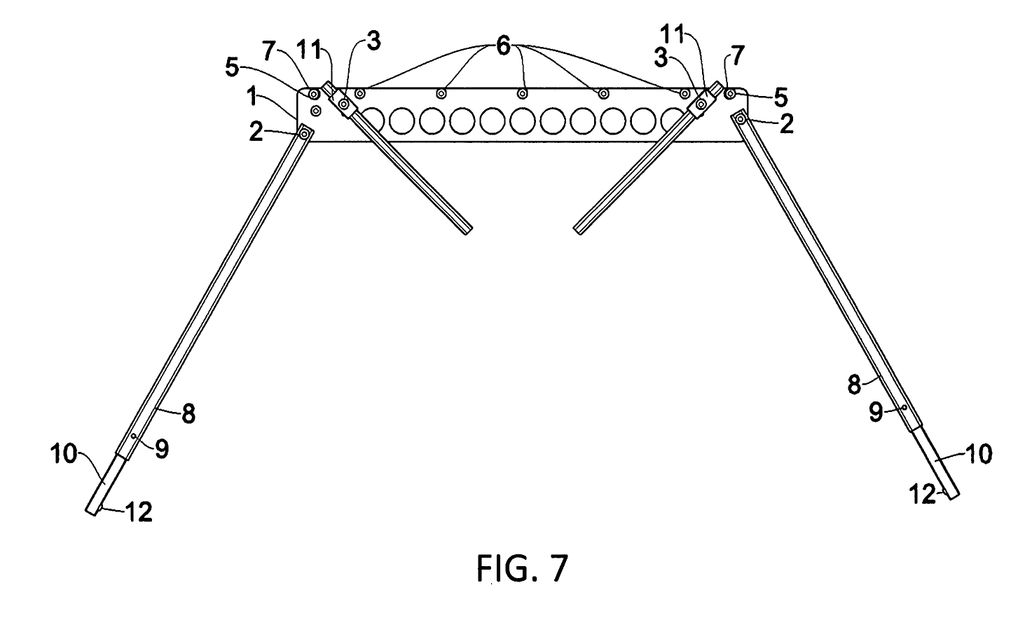

FIGS. 6-7 show the components from FIGS. 4-5 in different positions. FIG. 6 shows the arms 8 and 10 partially rotated out of the spanning member. FIG. 7 shows the arms 8 and 10 along with the stakes 11 partially rotated into the erect position.

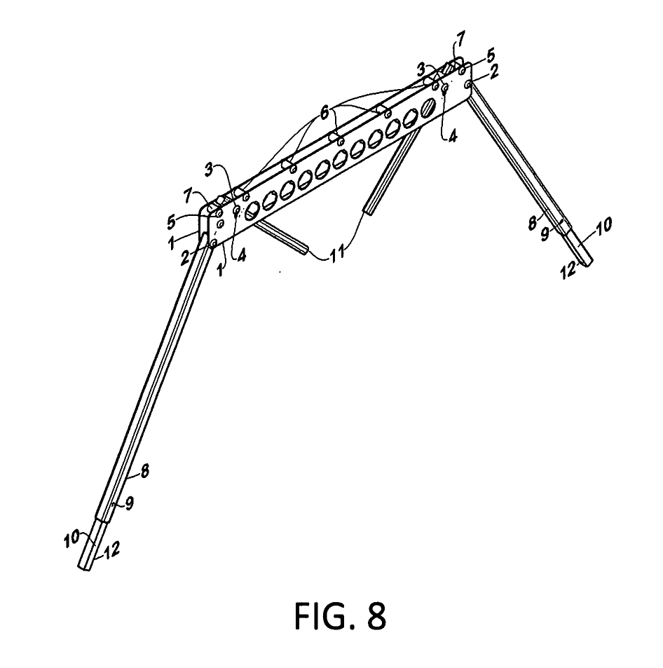

FIG. 8 depicts a spanning member, arms 8 and 10, and stakes 11 as depicted in FIG. 7, but with the second side plate 1 placed back on the spanning member.

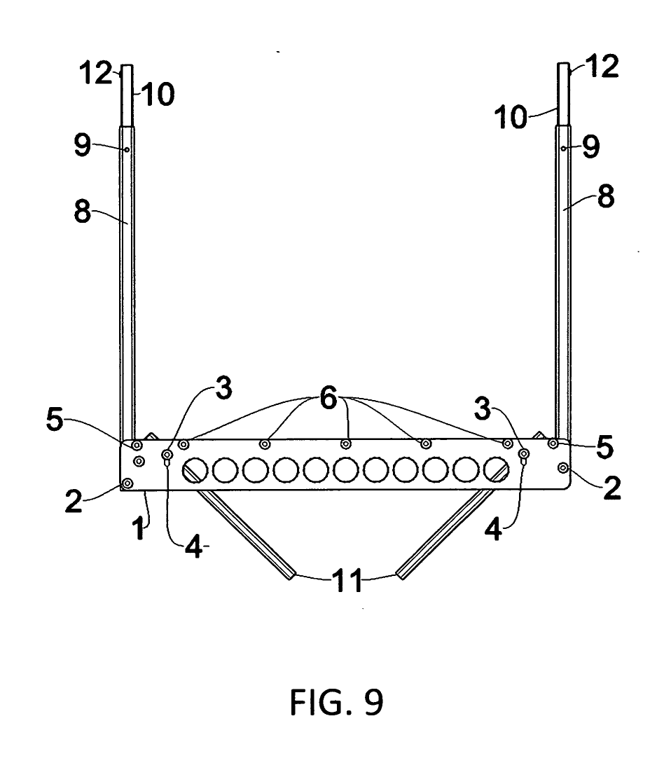

FIG. 9 illustrates a frame, and two strakes, with the arms 10 and 8 rotated into the erect positions more than 180° out of the spanning member. The arms 8 and 10 can rotate until they are stopped by an eccentric 7 that is held to the spanning member by a pin 5. During manufacturing the eccentric 7 can be rotated to adjust the angles of the arms 8 and 10 for fine tuning. The pins 5 can then be pressed in a riveting fashion to prevent the eccentric 7 from rotating. The plates 1 provide firm pressure on the arms 8 near the eccentric 7, squeezing it to allow the arms 8 and 10 to stay up on their own. The eccentric 7 can be extruded from aluminum and cut to the needed lengths.

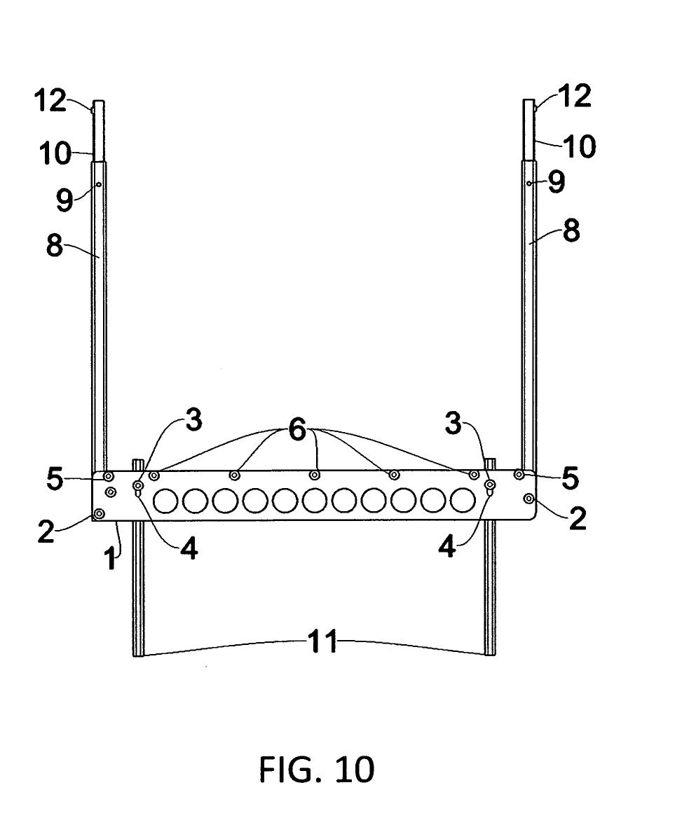

FIG. 10 shows that which is illustrated in FIG. 9 with the stakes 11 in the erect position. To put the stakes 11 in the ground, place the frame, as positioned in FIG. 10, with the stakes 11 on the ground vertical and parallel. Put the stakes 11 in the ground by alternating which stake 11 you hit with the hammer each time. This allows the spanning member to go down fairly level until it rests on the ground. Make sure that the spanning member is level after putting the stakes 11 in the ground. The stakes 11 are able to rotate more than 90° out of the spanning member to allow the spanning member to go into the ground an slight angles without creating additional stress on pins 3.

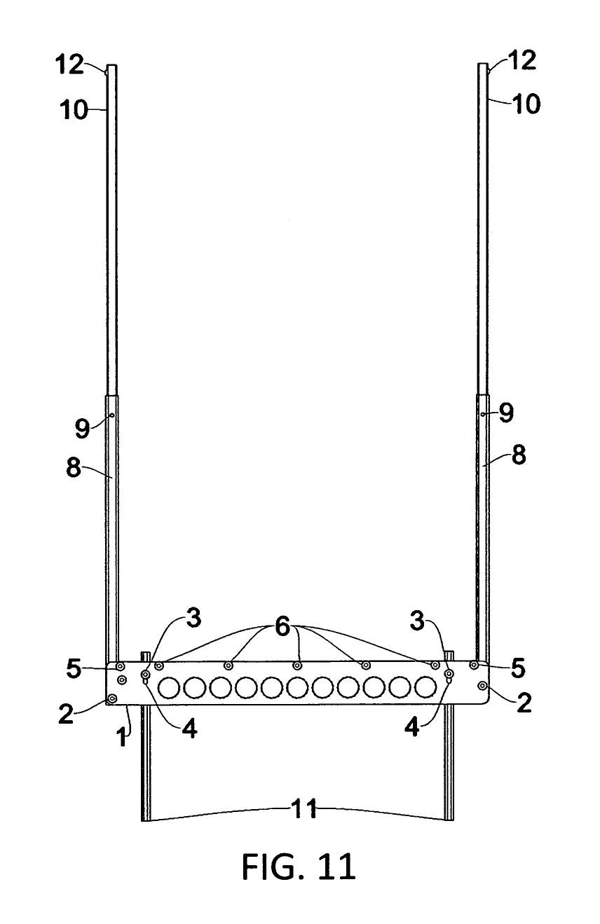

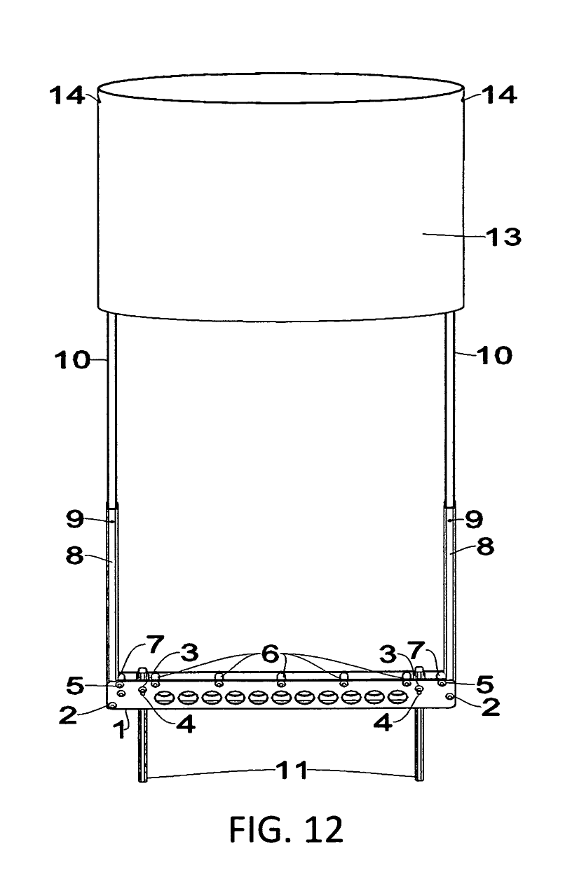

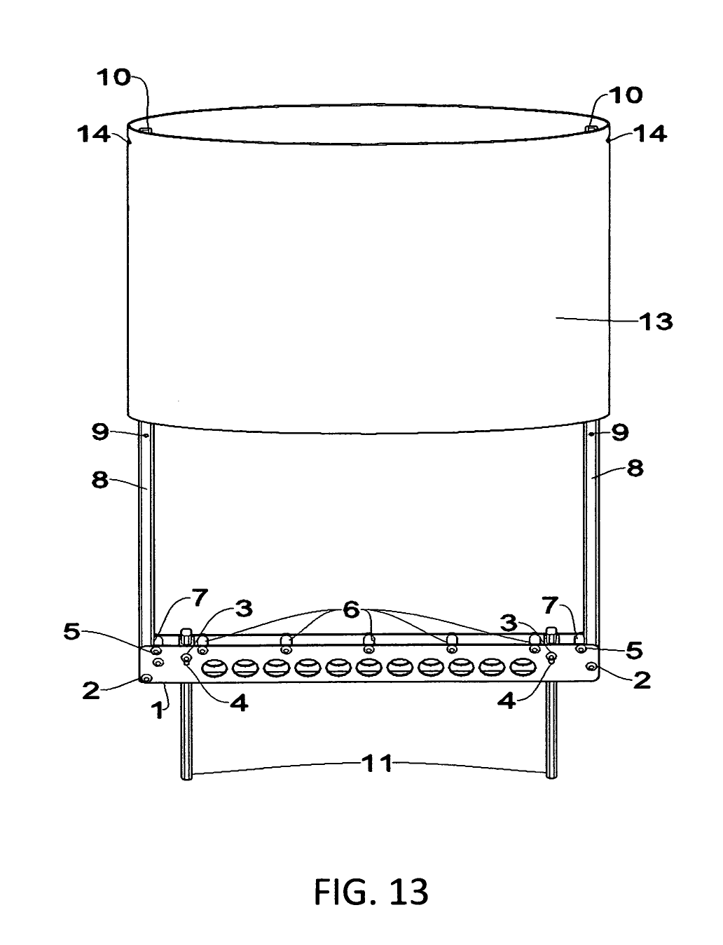

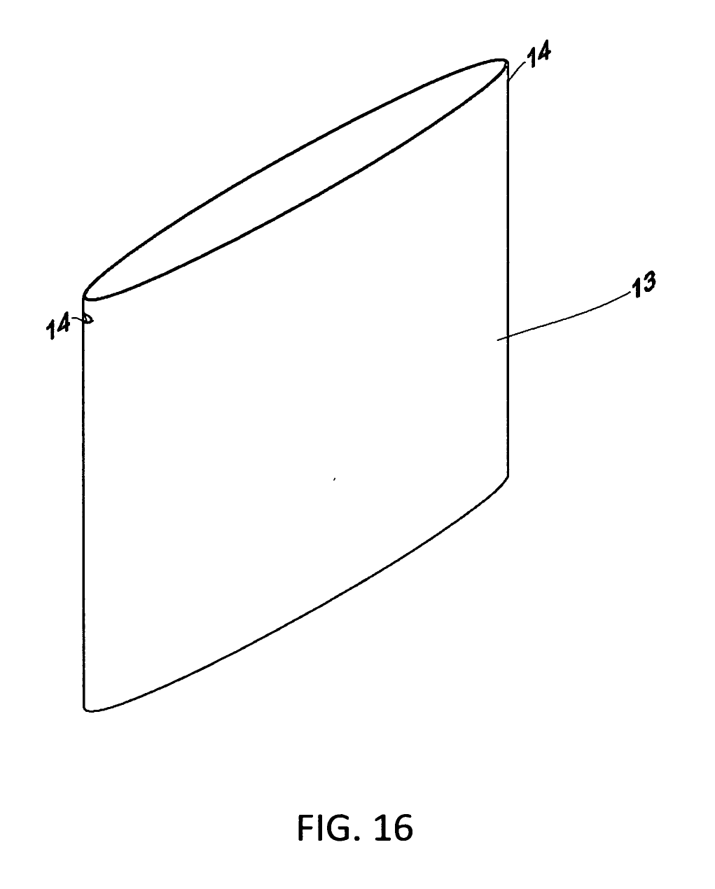

FIG. 11 shows that which is depicted in FIG. 10 with the arm components 10 extended into the erect position. The arm components 10 can be held in the extended position by utilizing a push button that pops through the holes 9 in the arms 8. The sign face 13 is constructed in the shape of a loop, and made from a flexible material as depicted in FIG. 16. The sign face 13 gets positioned over the tops of the extended arm components 10 as in FIG. 12, and slides down a portion of the arm components 10 as illustrated in FIG. 13. A protrusion 12 on each arm accommodate holes 14 in the sign face 13 securing the face 13 to the frame. The sign face 13 can be constructed of billboard or banner material with two printed images on the outside surface printed side by side. The two short ends of the printed material can be connected to form a loop with a heat seam. Holes 14 can be made using a press.

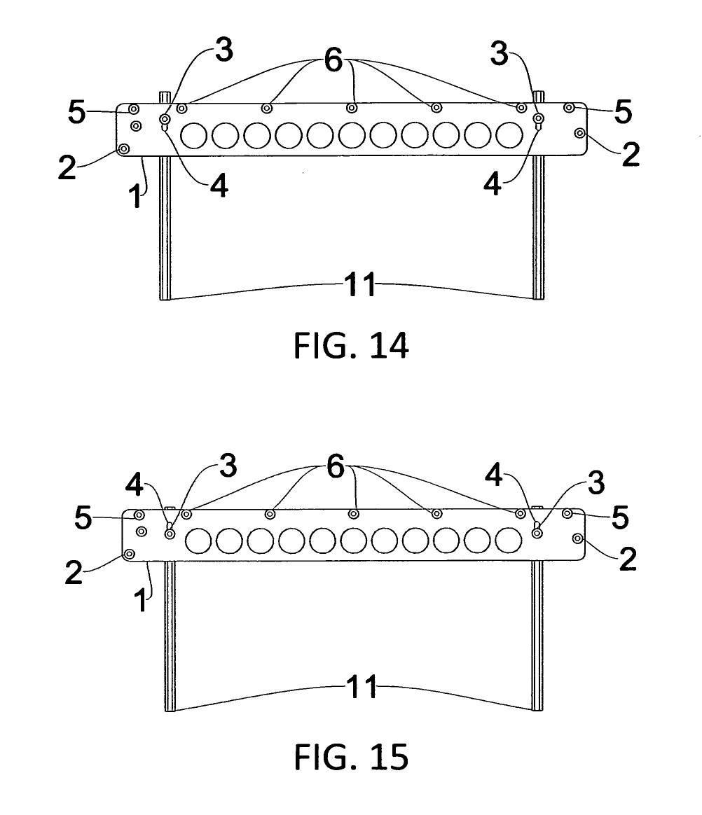

FIGS. 14 and 15 show the spanning member of FIG. 1 with two stakes 11 oriented perpendicular to the spanning member. The holes 4 that accommodate the pins 3, are loosely fitting around the pin 3 in the direction of hammering, to allow the stakes 11 to move up and down relative to the spanning member. FIG. 14 depicts the ideal position of the stakes 11, relative to the spanning member, before the stakes 11 get hit. Hitting the top of a stake 11 causes it to move into the position that is depicted in FIG. 15. Notice how the top of the stakes 11, before and after the hitting, always lie above the spanning member to avoid substantial damage to the spanning member. The stake 11 can then be repositioned back to the position in FIG. 14 for the next hit.

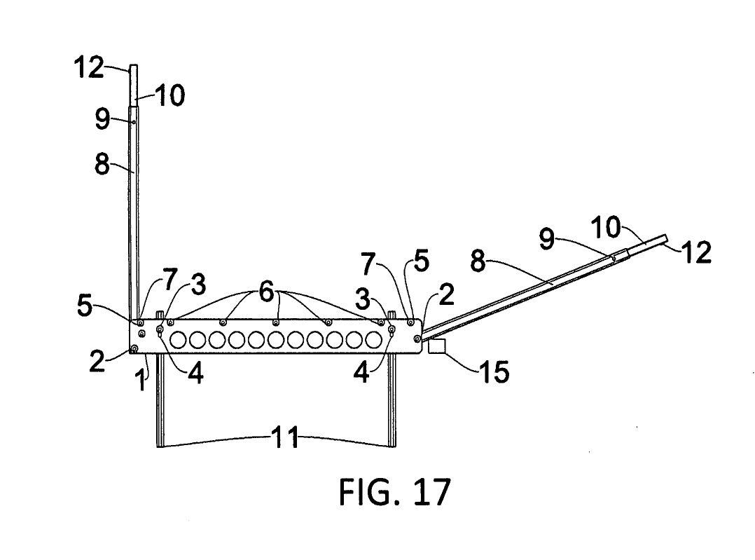

FIG. 17 shows a partially erect (open) frame, with two stakes, being removed from the ground (ground now shown). A block 15 is edged underneath one arm 8, near the pivot 2, so that the arm 8 can be used as a lever to removed the adjacent stake 11 from the ground. A force applied on arm 8 vertically down forces the adjacent stake 11 up. The block 15 can then be positioned by the other arm 8 in the same fashion for removing the other stake 11.

The present invention is designed to be compact to reduce initial shipping costs and to make it easier to use signs on a regular basis. The Compact Sign collapses down to less than 1/10 the space of traditional signs of equal face size making it extremely easy to store. The average size (real estate) Compact Sign collapses down to fit in a file cabinet to eliminate the need for sign barns and storage sheds. It is so compact that it fits in a baseball but size bag for easier carrying rather than having to lug around large, bulky sign frames. These are just some of the many problems solved by the Compact Sign. Traditional signs often require that you hammer on the frame, beating them up, in order to put the stakes in the ground. Compact Signs have a convenient design that allows you to hit directly on the tops of the stakes to mimimize damage to the frame itself. Many traditional sign designs require tools such as wrenches, pliers, or screwdrivers but the only tool needed for Compact Signs is a hammer to put it in the ground.

To use the invention, lay the closed sign on the ground in the desired location. Rotate one arm out of the spanning member, followed by the other. After rotating the arms into the erect position, hold the arms and lift the sign up; the stakes should fall (rotate) out of the spanning member on their own. Position the stakes so that they are parallel, and vertical on the ground. Alternate stakes as you hammer to lower the spanning member into the ground evenly. Once the spanning member is in the ground and level, extend the arms and slide the sign face over the top of each arm. Pull the sign face down until the protrusions in the arms poke through the holes in the face securing it to the frame.

What is claimed is:

1. A Compact Sign that comprises:
A rigid spanning member that establishes the proper spacing and position of two independently movable arms of a frame. The spanning member is jointly connected at, or near, one end of each arm such that the arms and spanning member lie within a small variation of a common plane. Two rays, one through the length of each arm, and extending from the joint through the furthest end, have a vertical component that has a common direction.
The spanning member helps to limit the motion of the arms of an erect frame such that in order to bring the arms of the erect frame immediately closed together requires that a bending moment be inducted in at least one arm. The face of the sign is suspended from the arms, and lies within a space that encompasses the immediate area around and between the arms of an erect frame.

2. The Compact Sign of claim 1 with at least one arm being adjustable in length.

3. The Compact Sign of claim 1 with at least one ground stakes that holds the frame in the upright position.

4. The Compact Sign of claim 3 with at least one ground stake attached to the spanning member, with a fastening mechanism, such that the ground stake is able to rotate relative to the spanning member and on a plane that is relatively parallel to the arms of the erect frame.

5. The Compact Sign of claim 4 where the fastening mechanism creates a loosely fitting relationship, in the direction of hammering, between a ground stake and the spanning member. The loosely fitting relationship allows for the stake to be accelerated into the ground while reducing the amount of stress on the spanning member.

6. The Compact Sign of claim 1 with a sign face that encloses a portion of at least one arm.

7. The Compact Sign of claim 6 where the sign face has at least one hold that accommodates a protrusion on the arm for securing the face to the frame.

8. A Compact Sign comprising:
A rigid spanning member that establishing the proper spacing and position between two independently movable arms of a frame. Each end of the spanning member is pivotally connected at, or near, the end of one arm. The arms of the erect frame are positioned such that they lie within a small variation of a common plane. Two rays, one through the length of each arm, and extending from the pivot through the furthest end, have a vertical component that has a common direction on the erect frame.
The spanning member helps to limit the motion of the arms such that in the erect position, there is a space between the arms that could be reduced by inducing a bending moment in the arm(s). The pivots allow the arms to rotate when closing the frame such that the arms can then collapse down to where they lie relatively parallel and adjacent to each other.
The face of the sign is suspended by the arms, and lies within a space that encompasses the immediate area around and between the arms of the erect frame.

9. The Compact Sign of claim 8 where at least one of the arms is adjustable in length.

10. The Compact Sign of claim 8 with at least one ground stake that supports the frame in the upright position.

11. The Compact Sign of claim 10 with at least one ground stake attached to the spanning member, with a fastening mechanism, such that the ground stake is able to rotate relative to the spanning member and in a plane that is relatively parallel to the arms of the erect frame. The stake(s) rotate such that they lie parallel to the spanning member in the closed position, and relatively perpendicular to the spanning member in the erect position.

12. The Compact Sign of claim 11 where the fastening mechanism creates a loosely fitting relationship, in the direction of hammering, between a ground stake and the spanning member. The loosely fitting relationship allows for the stake to be accelerated into the ground while reducing the amount of stress on the spanning member.

13. The Compact Sign of claim 8 with a sign face that encloses a portion of at least one arm.

14. The Compact Sign of claim 13 where the sign face has at least one hole that accommodates a protrusion on the arm for securing the face to the frame.

15. The Compact Sign of claim 8 where the spanning member consists of an arbitrarily shaped channel. The arms of the frame lie mostly inside the spanning member in the closed position and can be rotated out of the spanning member into the erect position.

16. The Compact Sign of claim 15 with at least one ground stake attached to the spanning member, with a fastening mechanism, such that the ground stake is able to rotate relative to the spanning member and in a plane that is relatively parallel to the arms of the erect frame. The stake(s) rotate such that they lie inside the spanning member and get covered on one side by the arms in the closed position. A stake rotates into the erect position in such a way that an end of the stake extends through a hole in the spanning member exposing the ends.

17. The Compact Sign of claim 15 where the arms rotate out of the spanning member more than 180° until they reach a stopping point that prevents them from rotating further. The arms of the frame can then be used to support the face by connecting them together.

18. The Compact Sign of claim 15 where the arms lie side by side, rather than end to end, in the closed position.

19. The Compact Sign of claim 16 such that the arms and stake (s) lie on a common plane in the closed position.

20. The Compact Sign of claim 17 where the arms rotate until they are almost parallel. The sign face then slides over a portion of each arm.

21. The Compact Sign of claim 8 that uses an eccentric to adjust the angle between the arms of an erect frame.
